(19) United States
(12) Patent Application Publication
(10) Pub. No.: US 2008/0254166 A1
(43) Pub. Date: Oct. 16, 2008

(54) Food Additives Containing Combinations of Prebiotics and Probiotics

(76) Inventor: Susan M. Potter, Decatur, IL (US)

Correspondence Address: WILLIAMS, MORGAN & AMERSON, P.C., 10333 RICHMOND, SUITE 1100, HOUSTON, TX, 77042, US

(21) Appl. No.: 11/970,046

(22) Filed: Jan. 7, 2008

Related U.S. Application Data
(60) Provisional application No. 60/886,542, filed on Jan. 25, 2007.

(51) Int. Cl. A23L 1/03

(52) U.S. Cl. 426/61

(57) ABSTRACT

Disclosed herein is a food additive containing at least one fiber source selected from the group consisting of digestion-resistant starch, digestion-resistant maltodextrin, digestion-resistant soluble fiber dextrin, digestion-resistant glucose syrup, pullulan, digestion-resistant hemicellulose, digestion-resistant corn syrup, digestion-resistant glucose syrup solids, digestion-resistant corn syrup solids, and digestion-resistant fructose oligomer syrup, wherein each fiber source is present in an amount of at least about 1 gram per 10 g food additive; and at least one probiotic organism selected from the group consisting of Lactobacillus spp., Bifidobacterium spp., Enterococcus spp., Escherichia spp., Streptococcus spp., and Saccharomyces spp., wherein each probiotic organism is present in an amount of at least 100 cells per 10 g food additive. Also disclosed herein is a fortified foodstuff, containing a base foodstuff and a food additive as described above.

This application claims priority from U.S. provisional patent application Ser. No. 60/886,542, filed on Jan. 25, 2007, which is incorporated herein by reference.

### BACKGROUND OF THE INVENTION

The present invention relates generally to the fields of fiber and probiotic organism fortification of foodstuffs. More particularly, it concerns a food additive containing a fiber source and a probiotic organism.

Fiber consumption in the United States and other developed countries is lower than is recommended by nutritional experts. Fiber, by which is meant both insoluble fiber, such as cellulose or related materials, and soluble fiber, by which is meant water-soluble carbohydrate materials at least partially indigestible by man, and which in either form may be referred to as a “prebiotic,” assists in gastrointestinal function and may lower the risk of developing type II diabetes, heart disease, high cholesterol, or obesity. The United States recommended daily value for fiber consumption for a person eating a 2000 calorie/day diet is 25 g, but it is estimated the average United States resident only consumes about 14-15 g per day. Therefore, it is desirable to have compositions capable of imparting dietary fiber to foodstuffs.

A probiotic organism is a microorganism which has a beneficial effect on a host's intestinal microflora ecology, presumably by promoting the growth of so-called “good” microorganisms, inhibiting the growth of so-called “bad” microorganisms, or by performing metabolic activities that are beneficial to the host. Despite the benefits of probiotic organisms, very few foods—primarily fermented dairy and cabbage foods such as yogurt, kefir, yakult, miso, natto, tempeh, kimchee, and sauerkraut—contain probiotic organisms. Therefore, it is desirable to have compositions capable of imparting probiotic organisms to foodstuffs.

### SUMMARY OF THE INVENTION

In one embodiment, the present invention relates to a food additive containing at least one fiber source selected from the group consisting of digestion-resistant starch, digestion-resistant maltodextrin, digestion-resistant soluble fiber dextrin, digestion-resistant glucose syrup, pullulan, digestion-resistant hemicellulose, digestion-resistant corn syrup, digestion-resistant glucose syrup solids, digestion-resistant corn syrup solids, and digestion-resistant fructose oligomer syrup, wherein each fiber source is present in an amount of at least about 1 gram per 10 g food additive; and at least one probiotic organism selected from the group consisting of Lactobacillus spp., Bifidobacterium spp., Enterococcus spp., Escherichia spp., Streptococcus spp., and Saccharomyces spp., wherein each probiotic organism is present in an amount of at least 100 cells per 10 g food additive.

In one embodiment, the present invention relates to a fortified foodstuff, containing a base foodstuff; at least one fiber source selected from the group consisting of digestion-resistant starch, digestion-resistant maltodextrin, digestion-resistant soluble fiber dextrin, digestion-resistant glucose syrup, pullulan, digestion-resistant hemicellulose, digestion-resistant corn syrup, digestion-resistant glucose syrup solids, digestion-resistant corn syrup solids, and digestion-resistant fructose oligomer syrup, wherein each fiber source is present in an amount of at least about 1 gram per serving of the fortified foodstuff, and at least one probiotic organism selected from the group consisting of Lactobacillus spp., Bifidobacterium spp., Enterococcus spp., Escherichia spp., Streptococcus spp., and Saccharomyces spp., wherein each probiotic organism is present in an amount of at least 100 cells per serving of the fortified foodstuff.

The food additives of the various embodiments of the present invention can impart dietary fiber and probiotic organisms to foodstuffs.

### DESCRIPTION OF ILLUSTRATIVE EMBODIMENTS

In one embodiment, the present invention relates to a food additive containing at least one fiber source selected from the group consisting of digestion-resistant starch, digestion-resistant maltodextrin, digestion-resistant soluble fiber dextrin, digestion-resistant glucose syrup, pullulan, digestion-resistant hemicellulose, digestion-resistant corn syrup, digestion-resistant glucose syrup solids, digestion-resistant corn syrup solids, and digestion-resistant fructose oligomer syrup, wherein each fiber source is present in an amount of at least about 1 gram per 10 g food additive; and at least one probiotic organism selected from the group consisting of Lactobacillus spp., Bifidobacterium spp., Enterococcus spp., Escherichia spp., Streptococcus spp., and Saccharomyces spp., wherein each probiotic organism is present in an amount of at least 100 cells per 10 g food additive.

The fiber source can provide insoluble fiber, such as cellulose or related materials, or soluble fiber, by which is meant water-soluble carbohydrate materials at least partially indigestible by man. In a further embodiment, the at least one fiber source is selected from the group consisting of digestion-resistant glucose syrup, digestion-resistant corn syrup, digestion-resistant glucose syrup solids, digestion-resistant corn syrup solids, digestion-resistant maltodextrin, and pullulan. These materials are water soluble, are generally perceived to have mild, innocuous flavors, and have little color compared to many other fiber sources.

“Digestion-resistant,” as used herein, refers to carbohydrate ingredients which, according to the Englyst Assay (an in vitro enzyme test that can be used to estimate the amounts of a carbohydrate ingredient that are rapidly digestible, slowly digestible or resistant to digestion, Euro. J. Clin. Nutr. (1992) 46:S33-S50), contain at least about 40 wt % d.s.b. materials classified as slowly digestible or as resistant to digestion. “Highly-digestion-resistant,” as used herein, refers to carbohydrate ingredients which contain at least about 50 wt % d.s.b materials classified as resistant to digestion according to the Englyst Assay.

In one embodiment, wherein the carbohydrate ingredient contains dextrose linkages, a digestion-resistant carbohydrate has at least some dextrose linkages as non-linear linkages (i.e., not α1→4 linkages). A glucose syrup is a carbohydrate material containing some mono- and disaccharides; syrup solids are the residue after dehydration of a syrup. A glucose syrup typically has a dextrose equivalence (DE) of greater than about 20. A maltodextrin is a carbohydrate material substantially free of mono- and disaccharides and typically having a DE less than about 20. The use of “glucose” in conjunction with the word “syrup” indicates that the carbohydrate material can be derived from any starch source, in contrast to the use of “corn,” which indicates the carbohydrate material is derived from cornstarch.

Herein, digestion-resistant glucose syrup, digestion-resistant corn syrup, digestion-resistant glucose syrup solids, digestion-resistant corn syrup solids, and digestion-resistant maltodextrin may be referred to generically as low molecular weight digestion resistant oligo- and polysaccharides. (“Low molecular weight,” in this context, means a carbohydrate material having an average molecular weight from about 360 da to about 3000 da).

Low molecular weight digestion resistant oligo- and polysaccharides can be prepared by techniques known in the art, such as the methods described by copending U.S. patent application Ser. No. 11/339,306, filed Jan. 25, 2006, which is hereby incorporated by reference.

To summarize, low molecular weight digestion resistant oligo- and polysaccharides can be prepared from a suitable starting material, examples of which include, but are not limited to, syrups made by hydrolysis of starch, such as dextrose greens syrup (i.e., recycle stream of mother liquor from dextrose monohydrate crystallization), other dextrose syrups, corn syrup, and solutions of maltodextrin. The starting material can be converted to nonlinear oligosaccharides by enzymatic reversion (such as by a glucoamylase enzyme composition or any other enzyme that acts on dextrose polymers) or acid reversion. Acid reversion can use any of a variety of acids, such as hydrochloric acid, sulfuric acid, phosphoric acid, or a combination thereof.

The acid treatment progresses differently than enzyme treatment. Enzymes rapidly hydrolyze linear oligomers and slowly form non-linear oligomers, whereas with acid the reduction in linear oligomers and the increase in non-linear oligomers occur at comparable rates. Dextrose is formed rapidly by enzymatic hydrolysis of oligomers, and consumed slowly as non-linear condensation products are formed, whereas with acid dextrose concentrations increase slowly before ultimately decreasing.

Optionally, enzymatic or acid reversion can be followed by hydrogenation. The hydrogenated product should have lower caloric content than currently available hydrogenated starch hydrolysates. In one embodiment, the hydrogenation can be used to decolorize the product composition without substantially changing its dextrose equivalence (DE). In another embodiment, the hydrogenation can be used to decrease the DE from a value of greater than about 10 to a value of less then about 10.

In one version of the process, enzyme and acid can be used sequentially, in any order.

The low molecular weight digestion resistant oligo- and polysaccharides described above can contain at least about 60 wt % d.s.b. indigestible oligosaccharides, and we have prepared formulations containing at least about 80 wt % d.s.b. indigestible oligosaccharides (defined herein as trisaccharides or higher-order oligosaccharides). The balance of low molecular weight digestion resistant oligo- and polysaccharides are primarily residual mono- and disaccharides. Exemplary low molecular weight digestion resistant oligo- and polysaccharides formulations of our preparation have from about 1.5 wt % d.s.b. to about 8.5 wt % d.s.b. monosaccharides, from about 3.5 wt % d.s.b. to about 4.5 wt % d.s.b. disaccharides, from about 4.0 wt % d.s.b. to about 4.5 wt % d.s.b. trisaccharides, and balance (from about 84 wt % d.s.b. to about 89 wt % d.s.b.) tetrasaccharides or higher-order oligosaccharides.

In a further embodiment, the food additive can contain at least two fiber sources selected from the group consisting of digestion-resistant starch, digestion-resistant maltodextrin, digestion-resistant soluble fiber dextrin, digestion-resistant glucose syrup, pullulan, digestion-resistant hemicellulose, digestion-resistant corn syrup, digestion-resistant glucose syrup solids, digestion-resistant corn syrup solids, and digestion-resistant fructose oligomer syrup.

In one embodiment, the food additive contains one or more low molecular weight digestion resistant oligo- and polysaccharides and pullulan. The combination of a higher molecular weight fiber source (higher than about 10,000 da, such as pullulan) and a lower molecular weight fiber source may provide improved dietary tolerance over a lower molecular weight fiber source alone in certain individuals.

In one embodiment, the at least one fiber source is digestion-resistant starch. In one embodiment, the at least one fiber source is digestion-resistant maltodextrin. In one embodiment, the at least one fiber source is digestion-resistant soluble fiber dextrin. In one embodiment, the at least one fiber source is digestion-resistant glucose syrup. In one embodiment, the at least one fiber source is pullulan. In one embodiment, the at least one fiber source is digestion-resistant hemicellulose. In one embodiment, the at least one fiber source is digestion-resistant corn syrup. In one embodiment, the at least one fiber source is digestion-resistant glucose syrup solids. In one embodiment, the at least one fiber source is digestion-resistant corn syrup solids. In one embodiment, the at least one fiber source is digestion-resistant fructose oligomer syrup.

In one embodiment, the at least one fiber source is highly-digestion-resistant starch. In one embodiment, the at least one fiber source is highly-digestion-resistant maltodextrin. In one embodiment, the at least one fiber source is highly-digestion-resistant soluble fiber dextrin. In one embodiment, the at least one fiber source is highly-digestion-resistant glucose syrup. In one embodiment, the at least one fiber source is pullulan. In one embodiment, the at least one fiber source is highly-digestion-resistant hemicellulose. In one embodiment, the at least one fiber source is highly-digestion-resistant corn syrup. In one embodiment, the at least one fiber source is highly-digestion-resistant glucose syrup solids. In one embodiment, the at least one fiber source is highly-digestion-resistant corn syrup solids. In one embodiment, the at least one fiber source is highly-digestion-resistant fructose oligomer syrup.

In one embodiment, the food additive can contain each fiber source in an amount of at least about 1 gram of each fiber source per 5 g food additive. In a further embodiment, the food additive can contain each fiber source in an amount of at least about 1 gram of each fiber source per 2 g food additive.

Probiotic organisms useful in the present invention include Lactobacillus spp., Bifidobacterium spp., Enterococcus spp., Escherichia spp., Streptococcus spp., and Saccharomyces spp. Specific organisms include, but are not limited to, Bifidobacterium bifidum, Bifidobacterium breve, Bifidobacterium infantis, Bifidobacterium longum, Lactobacillus acidophilus, Lactobacillus casei, Lactobacillus plantarum, Lactobacillus reuteri, and Lactobacillus rhamnosus, among others. Two or more probiotic organisms can be used in the food additive. It will be understood that any reference to cell counts of the probiotic organism or organisms is to viable cells only.

In one embodiment, the probiotic organism is a Lactobacillus. In one further embodiment, the probiotic organism is Lactobacillus acidophilus. In another further embodiment, the probiotic organism is Lactobacillus casei. In another further embodiment, the probiotic organism is Lactobacillus plantarum. In another further embodiment, the probiotic organism is Lactobacillus reuteri. In another further embodiment, the probiotic organism is Lactobacillus rhamnosus.

In one embodiment, the probiotic organism is a Bifidobacterium. In one further embodiment, the probiotic organism is Bifidobacterium bifidum. In another further embodiment, the probiotic organism is Bifidobacterium breve. In another further embodiment, the probiotic organism is Bifidobacterium infantis. In another further embodiment, the probiotic organism is Bifidobacterium longum.

In one embodiment, the probiotic organism is an Enterococcus.

In one embodiment, the probiotic organism is an Escherichia.

In one embodiment, the probiotic organism is a Streptococcus.

In one embodiment, the probiotic organism is a Saccharomyces.

The probiotic organism can be incorporated into the food additive as a culture in water or another liquid or semisolid medium in which the probiotic organism remains viable. In another technique, a freeze-dried powder containing the probiotic organism can be incorporated into a particulate material or liquid or semisolid material by mixing or blending.

In one embodiment, the food additive can contain each probiotic organism in an amount of at least 1000 cells per 10 g food additive. In one further embodiment, the food additive can contain each probiotic organism in an amount of at least 5000 cells per 10 g food additive. In another further embodiment, the food additive can contain each probiotic organism in an amount of at least 10,000 cells per 10 g food additive. In yet another further embodiment, the food additive can contain each probiotic organism in an amount of at least 100,000 cells per 10 g food additive. In still a further embodiment, the food additive can contain each probiotic organism in an amount of at least 1,000,000 cells per 10 g food additive.

The food additive can further contain other materials known in the art for inclusion in food additives, such as water or other aqueous solutions, starch, binders, thickeners, colorants, flavorants, odorants, acidulants (such as lactic acid or malic acid, among others), vitamins, or minerals, among others.

In one embodiment, the present invention relates to a fortified foodstuff, containing a base foodstuff; at least one fiber source selected from the group consisting of digestion-resistant starch, digestion-resistant maltodextrin, digestion-resistant soluble fiber dextrin, digestion-resistant glucose syrup, pullulan, digestion-resistant hemicellulose, digestion-resistant corn syrup, digestion-resistant glucose syrup solids, digestion-resistant corn syrup solids, and digestion-resistant fructose oligomer syrup, wherein each fiber source is present in an amount of at least about 1 gram per serving of the fortified foodstuff, and at least one probiotic organism selected from the group consisting of Lactobacillus spp., Bifidobacterium spp., Enterococcus spp., Escherichia spp., Streptococcus spp., and Saccharomyces spp., wherein each probiotic organism is present in an amount of at least 100 cells per serving of the fortified foodstuff.

The at least one fiber source and the at least one probiotic organism have been described above.

Any base foodstuff for which fiber and probiotic organism fortification is desired can be used. In one embodiment, the base foodstuff is selected from the group consisting of yogurt, kefir, yakult, miso, natto, tempeh, kimchee, sauerkraut, water, milk, fruit juices, vegetable juices, carbonated soft drinks, non-carbonated soft drinks, coffee, tea, beer, wine, liquor, alcoholic mixed drinks, bread, cakes, cookies, crackers, extruded snacks, soups, frozen desserts, fried foods, pasta products, potato products, rice products, corn products, wheat products, dairy products, confectioneries, hard candies, nutritional bars, breakfast cereals, bread dough, bread dough mix, sauces, processed meats, and cheeses.

In a particular embodiment, the base foodstuff comprises at least one solid portion and at least one semisolid portion; the at least one fiber source is present in at least the solid portion; and the at least one probiotic organism is present in at least the semisolid portion. The solid portion can be a baked good, such as a cake, a cookie, or a cracker, and the semisolid portion can be a spreadable cheese, a creme, or a comparable material. The solid portion and the semisolid portion can be disposed relative to one another in any manner. Common dispositions of the solid portion and the semisolid portion include a sandwich of the semisolid portion between two units of the solid portion and a filling of the semisolid portion into a pocket within the solid portion.

All of the compositions disclosed and claimed herein can be made and executed without undue experimentation in light of the present disclosure. While the compositions and methods of this invention have been described in terms of preferred embodiments, it will be apparent to those of skill in the art that variations may be applied to the compositions and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A food additive, comprising:
at least one fiber source selected from the group consisting of digestion-resistant starch, digestion-resistant maltodextrin, digestion-resistant soluble fiber dextrin, digestion-resistant glucose syrup, pullulan, digestion-resistant hemicellulose, digestion-resistant corn syrup, digestion-resistant glucose syrup solids, digestion-resistant corn syrup solids, and digestion-resistant fructose oligomer syrup, wherein each fiber source is present in an amount of at least about 1 gram per 10 g food additive; and
at least one probiotic organism selected from the group consisting of Lactobacillus spp., Bifidobacterium spp., Enterococcus spp., Escherichia spp., Streptococcus spp., and Saccharomyces spp., wherein each probiotic organism is present in an amount of at least 100 cells per 10 g food additive.

2. The food additive of claim 1, wherein the food additive comprises at least two fiber sources selected from the group consisting of digestion-resistant starch, digestion-resistant maltodextrin, digestion-resistant soluble fiber dextrin, digestion-resistant glucose syrup, pullulan, digestion-resistant hemicellulose, digestion-resistant corn syrup, digestion-resistant glucose syrup solids, digestion-resistant corn syrup solids, and digestion-resistant fructose oligomer syrup.

3. The food additive of claim 1, wherein each probiotic organism is present in an amount of at least 1000 cells per 10 g food additive.

4. The food additive of claim 1, wherein each fiber source is present in an amount of at least about 1 gram per 5 g food additive.

5. The food additive of claim 4, wherein each fiber source is present in an amount of at least about 1 gram per 2 g food additive.

6. A fortified foodstuff, comprising:
a base foodstuff,
at least one fiber source selected from the group consisting of digestion-resistant starch, digestion-resistant maltodextrin, digestion-resistant soluble fiber dextrin, digestion-resistant glucose syrup, pullulan, digestion-resistant hemicellulose, digestion-resistant corn syrup, digestion-resistant glucose syrup solids, digestion-resistant corn syrup solids, and digestion-resistant fructose oligomer syrup, wherein each fiber source is present in an amount of at least about 1 gram per serving of the fortified foodstuff; and
at least one probiotic organism selected from the group consisting of Lactobacillus spp., Bifidobacterium spp., Enterococcus spp., Escherichia spp., Streptococcus spp., and Saccharomyces spp., wherein each probiotic organism is present in an amount of at least 100 cells per serving of the fortified foodstuff.

7. The fortified food of claim 6, wherein the food additive comprises at least two fiber sources selected from the group consisting of digestion-resistant starch, digestion-resistant maltodextrin, digestion-resistant soluble fiber dextrin, digestion-resistant glucose syrup, pullulan, digestion-resistant hemicellulose, digestion-resistant corn syrup, digestion-resistant glucose syrup solids, digestion-resistant corn syrup solids, and digestion-resistant fructose oligomer syrup.

8. The fortified food of claim 6, wherein each probiotic organism is present in an amount of at least 1000 cells per serving of the fortified foodstuff.

9. The fortified food of claim 6, wherein the base foodstuff is selected from the group consisting of yogurt, kefir, yakult, miso, natto, tempeh, kimchee, sauerkraut, water, milk, fruit juices, vegetable juices, carbonated soft drinks, non-carbonated soft drinks, coffee, tea, beer, wine, liquor, alcoholic mixed drinks, bread, cakes, cookies, crackers, extruded snacks, soups, frozen desserts, fried foods, pasta products, potato products, rice products, corn products, wheat products, dairy products, confectionaries, hard candies, nutritional bars, breakfast cereals, bread dough, bread dough mix, sauces, processed meats, and cheeses.

10. The fortified food of claim 9, wherein the base foodstuff comprises at least one solid portion and at least one semisolid portion; the at least one fiber source is present in at least the solid portion; and the at least one probiotic organism is present in at least the semisolid portion.
